(19) United States
(12) Patent Application Publication
(10) Pub. No.: US 2015/0077494 A1
(43) Pub. Date: Mar. 19, 2015

(54) IMAGE FORMING APPARATUS AND SEPARATION MEMBER

(71) Applicants: Yuuzoh Obata, Tokyo (JP); Tohru Watanabe, Kanagawa (JP); Kazuyoshi Matsumoto, Tokyo (JP); Toshihisa Nakamura, Tokyo (JP); Makoto Kikura, Kanagawa (JP); Kazuyoshi Kondo, Tokyo (JP); Norikazu Yanase, Kanagawa (JP); Gaku Hosono, Kanagawa (JP)

(72) Inventors: Yuuzoh Obata, Tokyo (JP); Tohru Watanabe, Kanagawa (JP); Kazuyoshi Matsumoto, Tokyo (JP); Toshihisa Nakamura, Tokyo (JP); Makoto Kikura, Kanagawa (JP); Kazuyoshi Kondo, Tokyo (JP); Norikazu Yanase, Kanagawa (JP); Gaku Hosono, Kanagawa (JP)

(73) Assignee: RICOH COMPANY, LTD., Tokyo (JP)

(21) Appl. No.: 14/477,999

(22) Filed: Sep. 5, 2014

(30) Foreign Application Priority Data
Sep. 13, 2013 (JP) 2013-190720
Jun. 3, 2014 (JP) 2014-115199

(51) Int. Cl. B41J 11/00; B65G 47/76

(52) U.S. Cl. CPC B41J 11/007; B65G 47/763
USPC 347/104; 198/635

(57) ABSTRACT

An image forming apparatus includes an image forming device, a conveyor, and a separation unit. The image forming device forms an image on a printing medium. The separation unit separates a printing medium from the belt. The separation unit includes a claw portion to contact the belt, and a first wing and a second wing disposed at both sides of the claw portion in a direction perpendicular to a conveyance direction of the printing medium. Each of the first wing and the second wing has a guide face to guide the printing medium. The guide face is a sloped face that slopes downward in a direction away from the claw portion with respect to the direction perpendicular to the conveyance direction of the printing medium. Each of the first wing and the second wing has an upstream end that recedes toward a downstream side in the conveyance direction.

### CROSS-REFERENCE TO RELATED APPLICATIONS

This patent application is based on and claims priority pursuant to 35 U.S.C. §119(a) to Japanese Patent Application Nos. 2013-190720, filed on Sep. 13, 2013, and 2014-115199, filed on Jun. 3, 2014, in the Japan Patent Office, the entire disclosure of each of which is incorporated by reference herein.

### BACKGROUND

1. Technical Field

Embodiments of the present disclosure relate to an image forming apparatus and a separation member.

2. Description of the Related Art

Image forming apparatuses are used as printers, facsimile machines, copiers, plotters, or multi-functional devices having, e.g., two or more of the foregoing capabilities. As one type of image forming apparatuses, for example, an image forming apparatus, such as a label printer, is known that prints a rolled printing medium having an adhesive face on which a separation sheet is attached (hereinafter, also referred to as “linerless label sheet”), such as a label sheet having no tape or mount sheet, and cuts the printing medium to a desired length after printing to form a printing medium piece (hereinafter, “label piece”).

In such an image forming apparatus, for example, the printing medium is conveyed with the adhesive face of the printing medium protected by a belt member. In such a case, the printing medium needs to be reliably separated from the belt member.

The printing medium is separated from the belt member by, typically, curvature separation or a separation member, such as a separation claw. For example, such a belt member may include multiple belt segments and separation assist members between the multiple belt segments.

As described above, for a configuration in which a printing medium is separated with a separation member, there is a demand for stably and reliably separating the printing medium even if the printing medium is, e.g., a linerless label sheet having low stiffness.

### BRIEF SUMMARY

In at least one embodiment of this disclosure, there is provided an image forming apparatus including an image forming device, a conveyor, and a separation unit. The image forming device forms an image on a printing medium. The conveyor includes a belt to convey the printing medium. The separation unit separates the printing medium from the belt. The separation unit includes a claw portion and a first wing and a second wing. The claw portion contacts the belt. The first wing and the second wing are disposed at both sides of the claw portion in a direction perpendicular to a conveyance direction of the printing medium. Each of the first wing and the second wing has a guide face to guide the printing medium. The guide face is a sloped face that slopes downward in a direction away from the claw portion with respect to the direction perpendicular to the conveyance direction of the printing medium. Each of the first wing and the second wing has an upstream end in the conveyance direction that recedes toward a downstream side in the conveyance direction.

In at least one embodiment of this disclosure, there is provided a separation member for separating a printing medium from a belt. The separation member includes a claw portion and a first wing and a second wing. The claw portion contacts the belt. The first wing and the second wing are disposed at both sides of the claw portion in a direction perpendicular to a conveyance direction of the printing medium. Each of the first wing and the second wing has a guide face to guide the printing medium. The guide face is a sloped face that slopes downward in a direction away from the claw portion with respect to the direction perpendicular to the conveyance direction of the printing medium. Each of the first wing and the second wing has an upstream end in the conveyance direction that recedes toward a downstream side in the conveyance direction.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a front view of a mechanical section of an image forming apparatus according to an embodiment of this disclosure.

FIG. 2 is a partial front view of the mechanical section of FIG. 1 with a printing medium;

FIG. 3 is a partial perspective view of a separation unit serving as a separation assembly of the image forming apparatus illustrated in FIG. 1;

FIG. 4 is a front view of the separation unit illustrated in FIG. 3;

FIG. 5 is a perspective view of a separation member according to an embodiment of this disclosure;

FIG. 6 is an enlarged perspective view of a part of the separation member illustrated in FIG. 5;

FIG. 7 is a plan view of the separation member illustrated in FIG. 5;

FIG. 8A is a partial sectional view of the separation member cut along line A-A in FIG. 7.

FIG. 8B is a partial sectional view of the separation member cut along line B-B in FIG. 7;

FIG. 8C is a partial sectional view of the separation member cut along line C-C in FIG. 7;

FIGS. 9A and 9B are plan views of a separation member according to an embodiment of this disclosure;

FIGS. 10A and 10B are plan views of a separation member according to an embodiment of this disclosure;

FIG. 11 is a partial plan view of a separation unit according to an embodiment of this disclosure;

FIG. 12 is a partial plan view of a separation unit according to an embodiment of this disclosure;

FIG. 13 is a partial plan view of a separation unit according to an embodiment of this disclosure;

FIG. 14 is a partial perspective view of the separation unit illustrated in FIG. 13;

FIG. 15 is a partial plan view of a separation unit according to an embodiment of this disclosure; and

FIG. 16 is a partial plan view of a separation unit according to an embodiment of this disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION OF EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

For example, in this disclosure, the term “image formation” used herein includes providing not only meaningful images, such as characters and figures, but meaningless images, such as patterns, to e (in other words, the term “image formation” also includes causing liquid droplets to land on printing media).

The term “ink” is not limited to “ink” in a narrow sense, unless specified, but is used as a generic term for any types of liquid usable as targets of image formation. For example, the term “ink” includes recording liquid, fixing solution, liquid, and so on.

The term “image forming apparatus”, unless specified, also includes both serial-type image forming apparatus and line-type image forming apparatus.

Although the embodiments are described with technical limitations with reference to the attached drawings, such description is not intended to limit the scope of the disclosure and all of the components or elements described in the embodiments of this disclosure are not necessarily indispensable.

Referring now to the drawings, wherein like reference numerals designate identical or corresponding parts throughout the several views, embodiments of the present disclosure are described below.

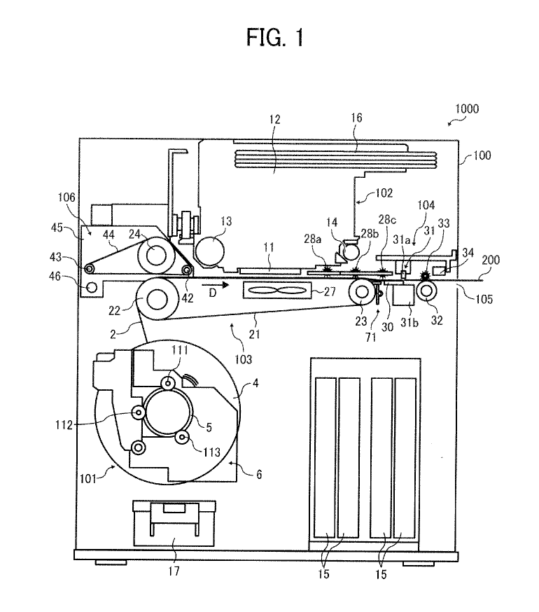

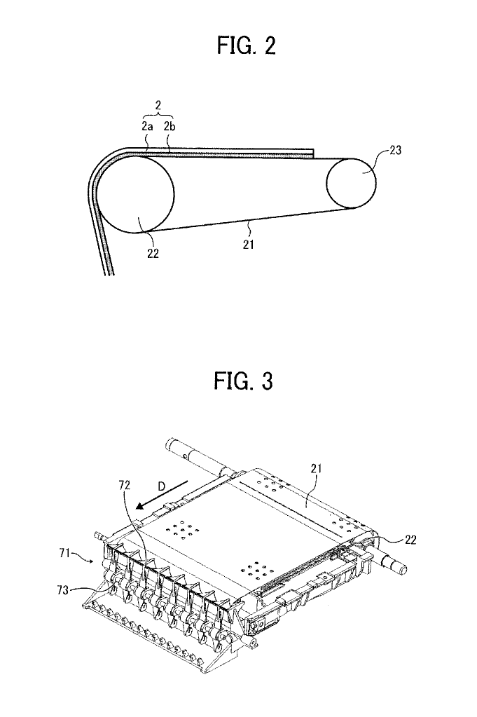

First, an image forming apparatus according to an embodiment of this disclosure is described with reference to FIGS. 1 and 2.

FIG. 1 is a front view of a mechanical section of an image forming apparatus according to an embodiment of this disclosure. FIG. 2 is a partial front view of the mechanical section with a printing medium.

As illustrated in FIG. 1, an image forming apparatus 1000 according to this embodiment has a sheet feeding unit 101 serving as a sheet feeder, an image forming unit 102 as an image forming device, a conveyance unit 103 as a conveyor, and a discharge conveyance unit 104 as a discharge conveyor within an apparatus body 100. The image forming apparatus 1000 also has a discharge port 105 and a guide unit 106. The discharge port 105 serves as a discharge port part to discharge a printing medium 2 having an image formed thereof to the outside of the apparatus body 100. The guide unit 106 guides a rolled printing medium 2 during conveyance and pull-back of the printing medium 2.

A media roll 4 formed of the rolled printing medium 2 is loaded on the sheet feeding unit 101.

As illustrated in FIG. 2, the printing medium 2 is a continuum having an image-formable medium (hereinafter, also referred to as “printing face”) 2a and an adhesive layer (hereinafter, referred to as “adhesive face”) 2b formed on a surface of the image-formable medium 2a. The printing medium 2 is a linerless label sheet rolled around in a state in which a mount sheet (separation sheet or separator) is not adhered to the adhesive face 2b.

The media roll 4 is engaged with a spool 5. Each of opposed ends of the spool 5 is rotatably held at three points, i.e., by a first roller 111, a second roller 112, and a third roller 113 serving as a first rotary body, a second rotary body, and a third rotary body, respectively.

The term “spool” used herein is not limited to a member that is provided separately from a core member and engaged with the core member for use. The spool may be held by roll holder members 6 as an integral part of the core member of the media roll 4. In a case in which the core member of the media roll 4 is directly held, the term “spool” includes the core member.

The image forming unit 102 includes a recording head 11 and a carriage 12. The recording head 11 is a liquid ejection head mounted on the carriage 12 to eject droplets onto a printing medium 2. The carriage 12 is supported by guide members 13 and 14 so as to be reciprocally movable along a direction (main scanning direction) perpendicular to a conveyance direction of the printing medium 2 indicated by arrow D in FIG. 1.

For this embodiment, a liquid ejection head having two nozzle rows is used as the recording head 11, and the carriage 12 mounts two recording heads 11. The two recording heads 11 eject ink droplets of, for example, black (K), cyan (C), magenta (M), and yellow (Y) from four nozzle rows. It is to be noted that the configuration of the recording head is not limited to the above-described configuration but may be other type of recording head, for example, a line-type recording head.

Ink cartridges 15 storing respective color inks are mounted to the apparatus body 100 in a replaceable manner. The color inks are supplied from the ink cartridges 15 to via supply tubes 16 to head tanks mounted on the carriage 12, and further supplied from the head tanks to the recording heads 11.

The image forming apparatus 1000 also has a waste liquid tank 17 mounted to the apparatus body 100 in a replaceable manner. For example, in a maintenance operation for maintaining and recovering the performance of the recording heads 11, waste ink is discharged into and stored in the waste liquid tank 17.

The image forming unit 102 is not limited to the above-described liquid ejection head but may be any other type of image forming unit to form an image in a contact or non-contact manner.

The conveyance unit 103 includes a protection belt 21 serving as an endless conveyance belt. The protection belt 21 is dispose below the recording heads 11. The protection belt 21 is looped around a conveyance roller 22 and a tensioned driven roller 23 so as to circulate.

The protection belt 21 preferably has no adhesion to the adhesive face 2b. However, to prevent the printing medium 21 from floating up from the protection belt 21 during conveyance, the protection belt 21 may have such low adhesion to the adhesive face 2b that the protection belt 21 is separatable from the adhesive face 2b. Pressing the protection belt 21 against the adhesive face 2b allows protection of the adhesive face 2b and prevents the adhesive face 2b from contacting components inside the image forming apparatus to allow stable conveyance of the printing medium 2. In addition, since the protection belt 21 is separatable from the adhesive face 2b, the printing medium 2 separated from the protection belt 21 is discharged from the discharge port 105.

In other words, in this embodiment, the protection belt 21 protects the adhesive face 2b of the printing medium 2 and is transported together with the printing medium 2.

An opposing roller 24 is disposed opposing the conveyance roller 22. A conveyance roller pair (in this embodiment, pair of rotary bodies) of the conveyance roller 22 and the opposing roller 24 constitutes a conveyor to sandwich the printing medium 2 and the protection belt 21 together and convey the printing medium 2 to an image forming region of the recording heads 11.

The protection belt 21 has multiple holes. Within a loop formed by the protection belt 21, a suction fan 27 is disposed opposing the recording heads 11 of the image forming unit 102. The suction fan 27 sucks the printing medium 2 toward a surface of the protection belt 21 via the suction holes.

In this embodiment, the printing medium 2 is adhered to the protection belt 21 by suction. However, it is to be noted that the force for adhering the printing medium 2 onto the protection belt 21 is not limited to suction force and may be, for example, electrostatic force. Alternatively, the printing medium 2 may be secured by adhesiveness of the adhesive face 2b so as not to float from the protection belt 21.

In addition, spur roller units 28a, 28b, and 28c are disposed near the driven roller 23. Each of the spur roller units 28a, 28b, and 28c has multiple spur rollers arranged in the direction perpendicular to the conveyance direction D. The upstream spur roller units 28a and 28b are disposed opposing the protection belt 21, and the most downstream spur roller unit 28c is disposed opposing a receive member 30 of the discharge conveyance unit 104.

A separation unit 71 is disposed downstream from the driven roller 23 to separate the printing medium 2 from the protection belt 21. The separation unit 71 includes a plurality of separation members 72 arranged side by side in an axial direction thereof.

The receive member 30 guides the printing medium 2 fed from between the protection belt 21 and the spur roller unit 28b. The discharge conveyance unit 104 has a cutter unit 31 serving as a cutting device to cut a printing medium 2 into a desired length to form a printing medium piece (label piece) 200. The discharge conveyance unit 104 is disposed downstream from the receive member 30 in the conveyance direction D of the printing medium 2.

The cutter unit 31 includes a lower blade 31b and a cutting blade (upper blade or cutter) 31a. The lower blade 31b is formed at a downstream edge surface of the receive member 30. The cutter 31a cuts the printing medium 2 between the lower blade 31b and the cutter 31a. The cutter 31a is moved in the direction perpendicular to the conveyance direction D to cut the printing medium 2.

A discharge roller 32 is disposed downstream from the cutter unit 31. A spur roller 33 is disposed opposing the discharge roller 32. The discharge roller 32 and the spur roller 33 hold the label piece 200, which is cut by the cutter unit 31, in a state in which a leading end of the label piece 200 is sent out to the discharge port 105 serving as a discharge port part of the apparatus body 100.

In this embodiment, a surface of the discharge roller 32 to hold the label piece 200 is, for example, non-adherence processed (processed so that the adhesive surface 2b does not adhere to the surface of the discharge roller 32), thus allowing separation of the adhesive surface 2b of the label piece 200. In some embodiments, the discharge roller 32 itself may be made of a material allowing separation of the adhesive surface 2b of the label piece 200.

A sheet sensor 34 is disposed to detect presence or absence of a printing medium 2. The sheet sensor 34 is constituted of, for example, a photosensor or a combination of a mechanical lever and a photosensor.

On a downstream side of the opposing roller 24 also serving as the first roller constituting the conveyance unit 103, the guide unit 106 has a second roller 42 serving as a separation roller disposed upstream from the image forming unit 102 and a third roller 43 disposed opposing the second roller 42 via the opposing roller 24. An endless guide belt 44 is looped around the opposing roller 24, the second roller 42, and the third roller 43.

The guide belt 44 is a belt member having a base member made of, e.g., polyimide and a release layer (e.g., silicone coating) as a surface layer to enhance the release performance of the guide belt 44.

The opposing roller 24, the second roller 42, and the third roller 43 are rotatably held by a holder member 45. The holder member 45 is rotatable around a shaft 46 and is displaceable between at a position at the opposing roller 24 opposes the conveyance roller 22 and a position at which the opposing roller 24 separates from the conveyance roller 22 to open a space between the opposing roller 24 and the conveyance roller 22.

When the media roll 4 is loaded and the printing medium 2 is set on the protection belt 21, the space between the opposing roller 24 and the conveyance roller 22 is opened. When the printing medium 2 is conveyed, the opposing roller 24 is pressed toward the conveyance roller 22. Accordingly, the opposing roller 24 is pressed toward the conveyance roller 22 by a pressing unit, such as a spring. In addition, the second roller 42 is pressed toward the protection belt 21 by a pressing unit, such as a spring.

In this embodiment, as described above, the printing medium 2 is placed on the protection belt 21 with the adhesive face 2b facing the protection belt 21, to perform image formation. Alternatively, a configuration may be employed in which an image is formed on the adhesive face 2b of the printing medium 2. In such a case, a surface of the guide belt 44 is preferably non-adherence processed (to prevent the adhesive face 2b from adhering thereto).

For the image forming apparatus 1000 having such a configuration, the protection belt 21 and the printing medium 2 pulled out from the media roll 4 loaded on the sheet feeding unit 101 are sandwiched together between the conveyance roller 22 and the opposing roller 24.

When the conveyance roller 22 is rotated, the printing medium 2b and the protection belt 21 are conveyed together in a state in which the adhesive face 2b is protected by the protection belt 21. A desired image is formed on the printing medium 2 by the recording heads 11 of the image forming unit 102.

When the protection belt 21 is separated from the printing medium 2 having the image formed thereon, the printing medium 2 is conveyed to the discharge conveyance unit 104 and cut at a desired position by the cutter unit 31 to form a label piece 200. The label piece 200 is held between the discharge roller 32 and the spur rollers 33 in a state in which the label piece 200 is extractable from the discharge port 105 of the apparatus body 100.

The guide unit 106 also prevents the printing medium 2 from being reeled by the opposing roller 24 during conveyance and pull-back of the printing medium 2, in particular, when an image is formed on the adhesive face 2b of the printing medium 2.

In other words, even if the surface of the opposing roller 24 is non-adherence processed, the adhesive face 2b of the printing medium 2 might adhere to the circumferential surface of the opposing roller 24 and be reeled by the opposing roller 24 due to a small curvature of the opposing roller 24. In such a case, it is conceivable to use a larger curvature of the opposing roller 24. However, a larger curvature of the opposing roller 24 reduces the size of a nip area between the opposing roller 24 and the conveyance roller 22, thus preventing obtainment of stable conveyance force.

Hence, during conveyance, the printing medium 2 is conveyed while being pressed by the guide belt 44, and the guide belt 44 is reliably separated from the printing medium 2 by the second roller 42 serving as a separation roller having a large curvature, thus preventing the printing medium 2 from being reeled by the opposing roller 24 during conveyance.

When the printing medium 2 is pulled back, the guide belt 44 receives the adhesive face 2b of the printing medium 2, thus preventing the printing medium 2 from being reeled by the opposing roller 24.

When image formation is finished and the printing medium 2 is cut by the cutter unit 31, the leading end of the printing medium 2 is at the position of the cutter unit 31 and an area of the printing medium 2 opposite the image forming unit 102 is an unused area. In such a state, if the next image forming operation is resumed, the unused area of the printing medium 2 is wasted. Hence, in this embodiment, the printing medium 2 is pulled back in a pull-back direction (opposite the conveyance direction of the printing medium 2) to a position at which the leading end of the printing medium 2 is placed upstream from the image forming unit 102 in the conveyance direction.

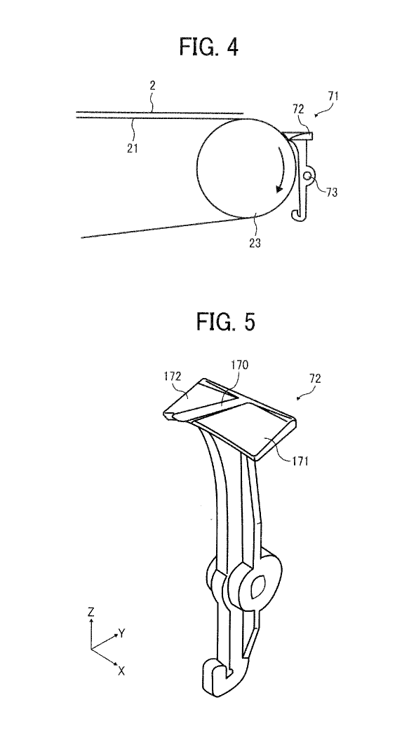

Next, a separation unit serving as a separation assembly of the image forming apparatus according to an embodiment of this disclosure is described with reference to FIGS. 3 and 4.

FIG. 3 is a partial perspective view of the separation unit according to this embodiment. FIG. 4 is a front view of the separation unit according to this embodiment.

The separation unit (separation assembly) 71 includes a plurality of separation members 72 and a shaft 73 to support the separation members 72. The separation members 72 separate a printing medium 2 from the protection belt 21 and guide the printing medium 2 in an area downstream from the driven roller 23 in the medium conveyance direction D. The separation members 72 are arranged side by side in a direction perpendicular to the medium conveyance direction D.

Here, separation members according to an embodiment of this disclosure is described with reference to FIGS. 5 to 7.

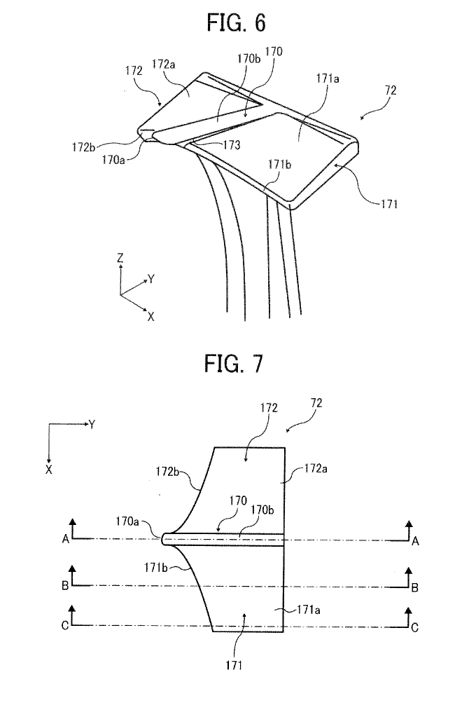

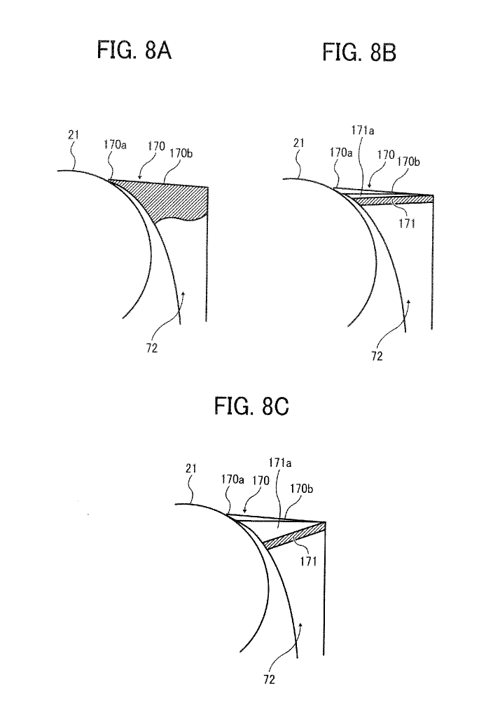

FIG. 5 is a perspective view of a separation member according to this embodiment FIG. 6 is an enlarged perspective view of a part of the separation member illustrated in FIG. 5. FIG. 7 is a plan view of the separation member illustrated in FIG. 5. FIG. 8A is a partial sectional view of the separation member cut along line A-A in FIG. 7. FIG. 8B is a partial sectional view of the separation member cut along line B-B in FIG. 7. FIG. 8C is a partial sectional view of the separation member cut along line C-C in FIG. 7.

It is to be noted that Y direction represents a direction parallel to the medium conveyance direction, X direction represents a direction perpendicular to the medium conveyance direction, and Z direction represents a height direction.

The separation member 72 includes a claw portion 170 to contact the protection belt 21, and a first wing 171 and a second wing 172 disposed at both sides of the claw portion 170 in the X direction perpendicular to the medium conveyance direction. The first wing 171 and the second wing 172 have a guide face 171a and a guide face 172a, respectively, to guide the printing medium 2. Each of the guide face 171a and the guide face 172a has a sloped shape. The claw portion 170, the first wing 171, and the second wing 172 are integrally molded as a single member.

Here, each of the guide face 171a and the guide face 172a is a sloped face that slopes downward in a direction away from the claw portion 170 in the X direction perpendicular to the medium conveyance direction.

Each of the guide face 171a and the guide face 172a is also a sloped face that slopes upward in a downstream direction from a tip 170a of the claw portion 170 so as to approach an upper surface of the claw portion 170.

In a plan view, as illustrated in FIG. 7, each of the guide face 171a and the guide face 172a is a sloped face in which upstream ends 171b and 172b in the medium conveyance direction recede toward a downstream side in the medium conveyance direction (Y direction), in other words, go farther away from the tip 170a of the claw portion 170 in the medium conveyance direction.

In FIG. 6, each of the guide face 171a and the guide face 171a slopes downward in X-Z plane in a direction away from the claw portion 170.

Since the upstream ends 171b and 172b recede toward the downstream side in the medium conveyance direction (Y direction), each of the guide face 171a and the guide face 172a slopes downward along a circumferential surface of the protection belt 21 (a circumferential surface of the driven roller 23).

In Y-Z plane, each of the guide face 171a and the guide face 172a also slopes upward in a downstream direction in the medium conveyance direction so as to approach the upper surface of the claw portion 170.

By contrast, the claw portion 170 has such a shape that only the tip 170a contacts the surface of the protection belt 21.

For the separation member 72 having the above-described configuration, immediately after the printing medium 2 is separated from the protection belt 21 by the tip 170a of the claw portion 170, slopes of the guide face 171a and the guide face 172a relative to the X-Z plane allow the back face (adhesive face 2b) of the printing medium 2 to be gradually supported outward from the vicinity of the claw portion 170. Such a configuration allows even the printing medium 2 having the adhesive face 2b to be separated from the protection belt 21.

For a configuration without the first wing 171 and the second wing 172, a portion of the printing medium 2 corresponding to the claw portion 170 is separated from the protection belt 21 at an exit of the protection belt 21. However, because of adhesiveness of the adhesive face 2b, areas of the printing medium 2 at both sides of the portion corresponding the claw portion 170 may be conveyed in a state in which the areas of the printing medium 2 adhere to the protection belt 21. As a result, the printing medium 2 may not be separated from the protection belt 21, thus causing a conveyance failure. Such a failure is likely to occur in, for example, a mountless label having low stiffness (linerless label sheet).

In addition, for the configuration without the first wing 171 and the second wing 172, the printing medium 2 is not gradually separated from the protection belt 21 at both sides of the claw portion 170. As a result, when the printing medium 2 adhering to the protection belt 21 arrives at the first wing 171 and the second wing 172, conveyance load rapidly may increase, thus hampering uniform feeding of the printing medium 2. In addition, the printing medium 2 contacts the protection belt 21 at an increased width, thus hampering smooth separation.

In addition, slopes of the guide face 171a and the guide face 172a (increasing in height toward the downstream side) relative to the Y-Z plane can suppress waving of the printing medium 2 separated from the protection belt 21 and feed the printing medium 2 to downstream processes (e.g., cutting process and discharge process) with a surface of the printing medium 2 maintained substantially flat. In other words, when the printing medium 2 is separated from the protection belt 21, slopes of the guide face 171a and the guide face 172a relative to the X-Z plane allow gradual separation of the printing medium 2 from the protection belt 21 with time lags. After the printing medium 2 passes the separation member 72, the slopes relative to the Y-Z plane allow the printing medium 2 to be conveyed in a substantially flat state.

By contrast, for a configuration without the slopes relative to the Y-Z plane, when the printing medium 2 is separated from the tip 170a of the claw portion 170, the guide face 171a, and the guide face 172a, waving of the printing medium 2 may occur (since the printing medium 2 is gradually separated with time lags by the slopes relative to the X-Z plane. As a result, when the printing medium 2 is relayed to downstream processes (e.g., cutting process and discharge process), a conveyance failure, such as a sheet jam, may occur. In particular, for a mountless label having low stiffness (linerless label sheet), such waving is likely to occur, thus causing a sheet jam.

In this embodiment, a step 173 is disposed between the claw portion 170 and each of the first wing 171 and the second wing 172. For such a configuration, immediately after the printing medium 2 is separated from the protection belt 21, the adhesive face 2b of the printing medium 2 contacts only the surface of the claw portion 170. As a result, a contact area of the printing medium 2 with the separation member 72 decreases, thus reducing conveyance load.

The step 173 decreases in height toward the downstream side in the medium conveyance direction. For such a configuration, after the printing medium 2 passes the separation member 72, the printing medium 2 is conveyed in a substantially flat state.

Hence, as described above, for the separation unit 71, the separation members 72 are arranged side by side in the direction perpendicular to the medium conveyance direction. Such a configuration allows the printing medium 2 to be reliably separated from the protection belt 21 and fed to the downstream side in a less wavy state.

Contact faces of the separation member 72 with the printing medium 2, for example, the surface of the claw portion 170, the guide face 171a of the first wing 171, and the guide face 172a of the second wing 172 are preferably non-adherence or unevenness processed.

Such a configuration reduces conveyance resistance of the printing medium 2, thus allowing the printing medium 2 to be stably fed to the downstream side.

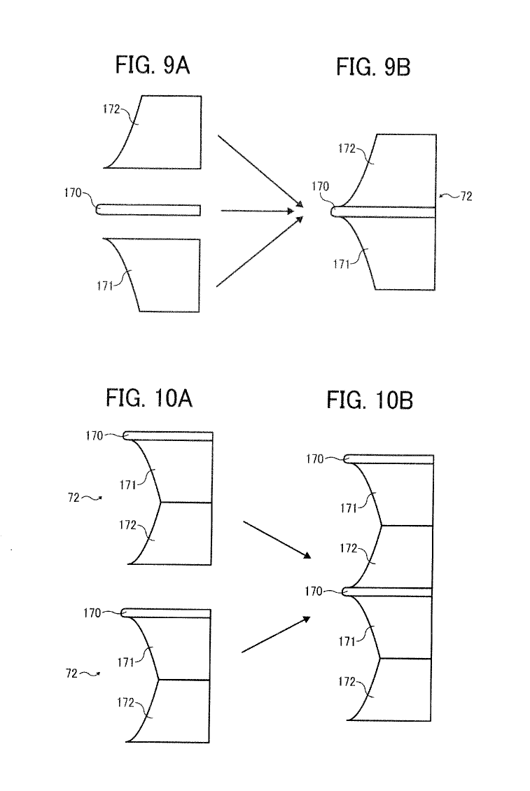

Next, separation members according to an embodiment of this disclosure is described with reference to FIGS. 9A and 9B.

FIGS. 9A and 9B are plan views of a separation member 72 according to this embodiment.

In this embodiment, as illustrated in FIG. 9A, the separation member 72 includes three members: a member having a claw portion 170, a member having a first wing 171, and a member having a second wing 172.

The three members are held by a shaft 73 equivalent to the shaft 73 illustrated in FIG. 3 to have an arrangement illustrated in FIG. 9B. Similarly with the above-described embodiment of FIG. 3, the arrangement illustrated in FIG. 9B is repeatedly arranged in the direction perpendicular to the medium conveyance direction.

Such a configuration can obtain operation effects equivalent to those of the above-described embodiment illustrated in FIG. 3. In addition, for this embodiment, each of the claw portion 170, the first wing 171, and the second wing 172 has a simple shape, thus facilitating highly precise processing.

Next, separation members according to an embodiment of this disclosure is described with reference to FIGS. 10A and 10B.

FIGS. 10A and 10B are plan views of separation members 72 according to this embodiment.

In this embodiment, as illustrated in FIG. 10A, the separation member 72 is constituted of a single member in which a first wing 171 and a second wing 172 are arranged in this order from an end of the claw portion 170 in a direction perpendicular to the medium conveyance direction.

Multiple separation members 72 are repeatedly arranged and held by a shaft similar to the shaft 73 illustrated in FIG. 3 so as to have an arrangement illustrated in FIG. 10B. Thus, the first wing 171 and the second wing 172 are disposed at both sides of the claw portion 170.

Such a configuration can obtain operation effects equivalent to those of the above-described embodiment illustrated in FIG. 3.

It is to be noted that the configuration of the separation member is not limited to the above-described embodiments. For example, the separation member may be a single member in which a second wing 172 and a first wing 171 may be arranged in this order from an end of the claw portion 170 in the direction perpendicular to the medium conveyance direction.

Alternatively, in an embodiment, a separation member may be constituted of two members: a single member including a claw portion 170 and a first wing 171 integrally molded and a member forming a second wing 172. Alternatively, in an embodiment, a separation member may be constituted of two members: a single member including a claw portion 170 and a second wing 172 integrally molded and a member forming a first wing 171.

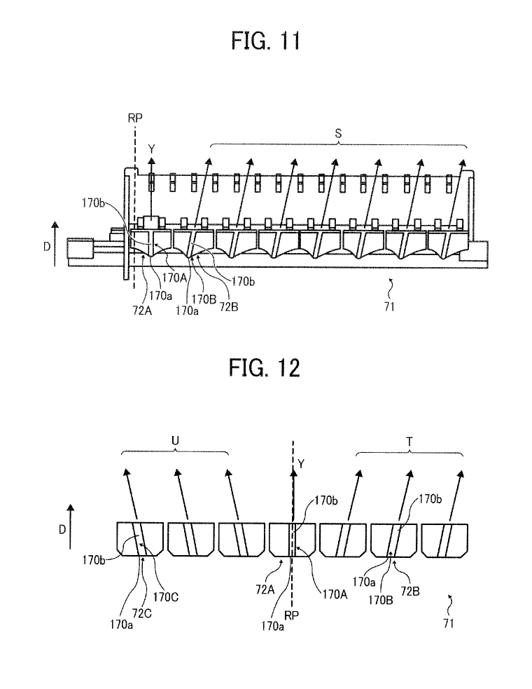

Next, a separation unit according to an embodiment of this disclosure is described with reference to FIG. 11.

FIG. 11 is a partial plan view of a separation unit 71 according to this embodiment.

In this embodiment, the separation unit 71 includes two types of separation members 72A and 72B. Hereinafter, separation members 72A and 72B are collectively referred to as separation members 72 unless distinguished. In this embodiment, an end of the printing medium 2 is used as a reference position RP to convey the printing medium 2. Hence, one of the separation members 72 closest to the reference position RP of the printing medium 2 is the separation member 72A. Two or more of the separation members 72 arranged side by side in the direction perpendicular to the medium conveyance direction are the separation members 72B.

The separation member 72A includes a claw portion 170A formed along a direction (indicated by arrow Y) parallel to the medium conveyance direction D in a plan view illustrated in FIG. 11. The claw portion 170A has a rib shape and includes a tip 170a to contact a protection belt 21 and a downstream portion 170b from the tip 170a in the medium conveyance direction D to support conveyance of the printing medium 2 separated from the protection belt 21.

Each of the separation members 72B includes a claw portion 170B in a direction (indicated by arrow S) tilted relative to the medium conveyance direction D in the plan view illustrated in FIG. 11. The claw portion 170B has a rib shape and includes a tip 170a to contact the protection belt 21 and a downstream portion 170b from the tip 170a in the medium conveyance direction D to support conveyance of the printing medium 2 separated from the protection belt 21. In other words, the claw portions 170 (170B in this embodiment) in at least a part of the separation members 72 are tilted relative to the medium conveyance direction in the plan view.

In this embodiment, toward a downstream side in the medium conveyance direction D in the plan view, the claw portion 170B of the separation member 72B is tilted in a direction away from the reference position RP of the printing medium.

For such a configuration, when the printing medium 2 passes the separation members 72A and 72B, force acts on the printing medium 2 in the direction S from the claw portions 170B of the separation members 72B. In other words, the printing medium 2 receives spreading force from the tilt of the rib-shaped claw portions 170B in the direction S relative to the medium conveyance direction D.

Such a configuration prevents occurrences of bending or paper wrinkles of the printing medium 2, thus allowing stable conveyance.

Next, a separation unit according to an embodiment of this disclosure is described with reference to FIG. 12.

FIG. 12 is a partial plan view of a separation unit 71 according to this embodiment.

In this embodiment, the separation unit 71 includes three types of separation members 72A, 72B, and 72C. Hereinafter, separation members 72A, 72B, and 72C are collectively referred to as separation members 72 unless distinguished. In this embodiment, a middle portion of a printing medium 2 is used as a reference position RP to convey the printing medium 2. Hence, one of the separation members 72 corresponding to the reference position RP of the printing medium 2 is the separation member 72A.

Two or more of the separation members 72 arranged at the right side of the separation member 72A in the direction perpendicular to the medium conveyance direction are the separation members 72B. Two or more of the separation members 72 arranged at the left side of the separation member 72A in the direction perpendicular to the medium conveyance direction are the separation members 72C.

Similarly with the above-described embodiment illustrated in FIG. 11, the separation member 72A includes a claw portion 170A formed along a direction (indicated by arrow Y) parallel to the medium conveyance direction D in a plan view illustrated in FIG. 12. The claw portion 170A has a rib shape and includes a tip 170a to contact a protection belt 21 and a downstream portion 170b from the tip 170a in the medium conveyance direction D to support conveyance of the printing medium 2 separated from the protection belt 21.

Similarly with the above-described embodiment illustrated in FIG. 11, each of the separation members 72B includes a claw portion 170B in a direction (indicated by arrow T) tilted relative to the medium conveyance direction D in the plan view illustrated in FIG. 12. The claw portion 170B has a rib shape and includes a tip 170a to contact the protection belt 21 and a downstream portion 170b from the tip 170a in the medium conveyance direction D to support conveyance of the printing medium 2 separated from the protection belt 21. In this embodiment, toward a downstream side in the medium conveyance direction D in the plan view, the claw portion 170B of the separation member 72B is tilted in a rightward direction away from the reference position RP of the printing medium.

Each of the separation members 72C includes a claw portion 170C in a direction (indicated by arrow U) tilted relative to the medium conveyance direction D in the plan view illustrated in FIG. 12. The claw portion 170C has a rib shape and includes a tip 170a to contact the protection belt 21 and a downstream portion 170b from the tip 170a in the medium conveyance direction D to support conveyance of the printing medium 2 separated from the protection belt 21. In this embodiment, toward a downstream side in the medium conveyance direction D in the plan view, the claw portion 170C of the separation member 72C is tilted in a leftward direction away from the reference position RP of the printing medium.

For such a configuration, when the printing medium 2 passes the separation members 72A, 72B, and 72C, force acts on the printing medium 2 in the direction T and the direction U from the claw portions 72B and the claw portions 170C, respectively. In other words, from the tilt of the rib-shaped claw portions 170B and 170C in the medium conveyance direction D, the printing medium 2 receives forces spreading leftward and rightward from the reference position RP.

Such a configuration prevents occurrences of bending or paper wrinkles of the printing medium 2, thus allowing stable conveyance.

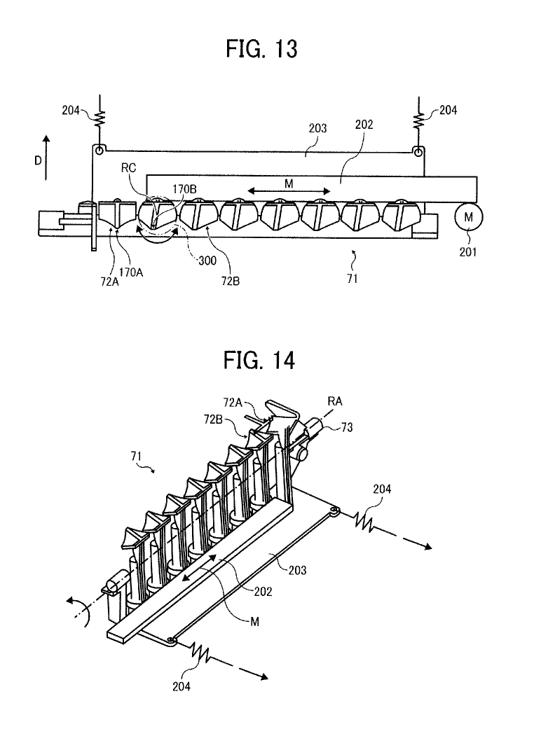

Next, a separation unit according to an embodiment of this disclosure is described with reference to FIGS. 13 and 14.

FIG. 13 is a partial plan view of a separation unit 71 according to this embodiment. FIG. 14 is a partial perspective view of the separation unit 71 according to this embodiment.

In this embodiment, similarly with the above-described embodiment illustrated in FIG. 11, the separation unit 71 includes a separation member 72A and two or more separation members 72B. The separation member 72A has a claw portion 170A formed along the medium conveyance direction D. Each of the separation members 72B has a claw portion 170B tilted relative to the medium conveyance direction D in a plan view of FIG. 13. The separation member 72A and the separation members 72B are arranged side by side on a holder 203.

Here, the separation members 72B are rotatably arranged on the holder 203 in the plan view of FIG. 13. In the plan view, each of the rotatable separation members 72B has a configuration (outer circumferential shape) in which an inscribed circle 300 around a rotation center RC thereof does not interfere with an inscribed circle of an adjacent separation member 72B.

Thus, when the separation members 72B are rotated, adjacent ones of the separation members 72B do not interfere with each other, thus allowing the direction of the claw portion 170B.

A rack 202 is disposed on the holder 203 so as to be reciprocally movable in a direction indicated by arrow M (in which the separation members 72B are arranged side by side). The separation members 72B are coupled to the rack 202. The rack 202 is reciprocally moved by a motor 201 along the direction M. In this embodiment, all of the separation members 72B are coupled to the rack 202 so as to be collectively rotated.

For such a configuration, in an initial state, as illustrated in FIG. 13, the separation members 72B are arranged so that the claw portions 170B are tilted in such a direction as to spread downward relative to the medium conveyance direction D.

Similarly with the above-described embodiment illustrated in FIG. 12, such a configuration prevents occurrences of bending or paper wrinkles of the printing medium 2, thus allowing stable conveyance.

By contrast, when the printing medium 2 is wound back, the motor 201 moves the rack 202 to invert the tilt direction of the claw portion 170B of each separation member 72B. Thus, the claw portion 170B is tilted in such a direction as to spread toward the upstream side with respect to the medium conveyance direction D.

Even when the printing medium 2 is wound back, such a configuration prevents occurrences of bending or paper wrinkles of the printing medium 2 passing on the separation members 72, thus allowing stable conveyance.

In addition, in this embodiment, an elastic member 204, such as a spring, is mounted on the holder 203 to apply force in a direction in which the holder 203 rotates around a rotation axis RA (a shaft 73).

Such a configuration allows the separation members 72 to be pressed against (contact) the conveyance belt 21 at a constant pressure (abutting pressure or contact pressure) regardless of a change in the axial position of the tension roller 23 due to, e.g., expansion and contraction of the conveyance belt 21.

In this embodiment, as described above, the separation members 72B having the tilted claw portion 170B are rotatable. However, the configuration of the separation members 72 is not limited to the configuration of this embodiment. For example, instead of the separation members 72B, separation members 72 having non-tilted claw portions 170 may be employed. (However, similarly with the separation members 72B, the separation members 72 have such an outer circumferential shape that adjacent ones of the separation members 72 do not interfere with each other.)

In such a case, for rotatable ones of the separation members 72, the separation members 72 are rotatable between a position at which the claw portions 170 are parallel to the medium conveyance direction D and a position at which the claw portions 170 are tilted relative to the medium conveyance direction D. Not only when the printing medium 2 is wound back but also when the printing medium 2 is fed, the direction of the claw portions 170 is adjustable in accordance with the printing medium 2 conveyed.

Next, a separation unit according to an embodiment of this disclosure is described with reference to FIG. 1S.

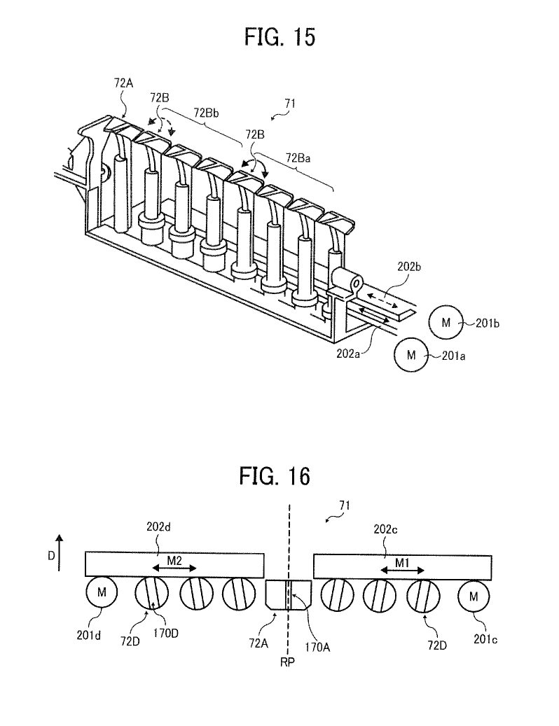

FIG. 15 is a partial plan view of a separation unit 71 according to this embodiment.

In this embodiment, multiple separation members 72B are divided to two groups: a first group 72Ba and a second group 72Bb. Separation members 72B of the first group 72Ba are coupled to a rack 202a and reciprocally moved by a motor 201a. Separation members 72B of the second group 72Bb are coupled to a rack 202b and moved by a motor 201b.

For such a configuration, the multiple separations members 72B are divided into groups, and the direction of the claw portions 170B is adjustable for each group.

Next, a separation unit according to an embodiment of this disclosure is described with reference to FIG. 16.

FIG. 16 is a partial plan view of a separation unit 71 according to this embodiment.

In this embodiment, the separation unit 71 includes a separation member 72A and separation members 72D. The separation members 72D have a circular outer circumference in a plan view. As illustrated in FIG. 16, two or more of the separation members 72D are arranged at each of the left side and the right side of the separation member 72A disposed at a middle portion of the separation unit 71.

Each of the separation members 72D arranged at the right side of the separation member 72A in a direction perpendicular to the medium conveyance direction D has a rib-shaped claw portion 170D. The claw portion 170D is coupled to a rack 202c in a state in which, toward a downstream side in the medium conveyance direction D, the claw portion 170D is sloped in a rightward direction away from a reference position RP of the printing medium.

Each of the separation members 72D arranged at the left side of the separation member 72A in a direction perpendicular to the medium conveyance direction D has a rib-shaped claw portion 170D. The claw portion 170D is coupled to a rack 202d in a state in which, toward a downstream side in the medium conveyance direction D, the claw portion 170D is sloped in a leftward direction away from the reference position RP of the printing medium.

The rack 202c and the rack 202d are reciprocally moved by a motor 201c and a motor 201d along a direction M1 and a direction M2, respectively.

Accordingly, when a printing medium conveyed based on a central reference position is wound back, the separation members 72D can have different tilt directions between the left side and the right side of the separation member 72A. Such a configuration prevents occurrences of bending or paper wrinkles of the printing medium 2, thus allowing stable conveyance.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An image forming apparatus, comprising:
an image forming device to form an image on a printing medium;
a conveyor including a belt to convey the printing medium; and
a separation unit to separate the printing medium from the belt, the separation unit including
a claw portion to contact the belt, and
a first wing and a second wing disposed at both sides of the claw portion in a direction perpendicular to a conveyance direction of the printing medium,
each of the first wing and the second wing having a guide face to guide the printing medium, the guide face being a sloped face that slopes downward in a direction away from the claw portion with respect to the direction perpendicular to the conveyance direction of the printing medium,
each of the first wing and the second wing having an upstream end in the conveyance direction that recedes toward a downstream side in the conveyance direction.

2. The image forming apparatus according to claim 1, wherein the guide face of each of the first wing and the second wing increases in height from an upstream side in the conveyance direction toward the downstream side in the conveyance direction.

3. The image forming apparatus according to claim 1, wherein each of the first wing and the second wing includes a step between the guide face and a contact face of the claw portion with the printing medium, and
wherein the step decreases in height from an upstream side in the conveyance direction toward the downstream side in the conveyance direction.

4. The image forming apparatus according to claim 1, wherein only a tip of the claw portion is to contact the belt.

5. The image forming apparatus according to claim 1, wherein the separation unit includes a separation member in which the claw portion, the first wing, the second wing are integrally molded as a single member.

6. The image forming apparatus according to claim 1, wherein the separation unit includes a separation member in which a first wing and a second wing are arranged in this order from an end of the claw portion in the direction perpendicular to the conveyance direction.

7. The image forming apparatus according to claim 1, wherein the separation unit is arranged in plural in the direction perpendicular to the conveyance direction.

8. The image forming apparatus according to claim 1, wherein a contact face of the separation unit with the printing medium is non-adherence or unevenness processed.

9. The image forming apparatus according to claim 1, wherein the separation unit is arranged in plural in the direction perpendicular to the conveyance direction,
wherein the claw portion has a rib shape and includes a tip to contact the belt and a downstream portion from the tip in the conveyance direction to support the printing medium separated from the belt, and
wherein, in at least a part of the separation unit arranged in plural, the claw portion is tilted relative to the conveyance direction in a plan view.

10. The image forming apparatus according to claim 1, wherein the separation unit is arranged in plural in the direction perpendicular to the conveyance direction,
wherein the claw portion has a rib shape and includes a tip to contact the belt and a downstream portion from the tip in the conveyance direction to support the printing medium separated from the belt, and
wherein at least a part of the separation unit arranged in plural is rotatable in such a direction that the claw portion is tilted relative to the conveyance direction in a plan view.

11. The image forming apparatus according to claim 10, wherein the at least a part of the separation unit arranged in plural is rotatable collectively or group by group to adjust a direction of the claw portion.

12. The image forming apparatus according to claim 10, wherein, when the printing medium is pulled beck, the at least a part of the separation unit arranged in plural is rotated so that the claw portion is parallel to the conveyance direction.

13. A separation member for separating a printing medium from a belt, the separation member comprising:
a claw portion to contact the belt; and
a first wing and a second wing disposed at both sides of the claw portion in a direction perpendicular to a conveyance direction of the printing medium,
each of the first wing and the second wing having a guide face to guide the printing medium, the guide face being a sloped face that slopes downward in a direction away from the claw portion with respect to the direction perpendicular to the conveyance direction of the printing medium,
each of the first wing and the second wing having an upstream end in the conveyance direction that recedes toward a downstream side in the conveyance direction.

14. The separation member according to claim 13, wherein the guide face of each of the first wing and the second wing increases in height from an upstream side in the conveyance direction toward the downstream side in the conveyance direction.
